(19) United States
(12) Patent Application Publication
(10) Pub. No.: US 2012/0185651 A1
(43) Pub. Date: Jul. 19, 2012

(54) MEMORY-ACCESS CONTROL CIRCUIT, PREFETCH CIRCUIT, MEMORY APPARATUS AND INFORMATION PROCESSING SYSTEM

(75) Inventor: Yoshitaka Kimori, Tokyo (JP)

(73) Assignee: Sony Corporation, Tokyo (JP)

(21) Appl. No.: 13/313,733

(22) Filed: Dec. 7, 2011

(30) Foreign Application Priority Data
Jan. 17, 2011 (JP) 2011-006574

(51) Int. Cl. G06F 12/08

(52) U.S. Cl. 711/137; 711/E12.057

(57) ABSTRACT

Disclosed herein is a memory-access control circuit including: a prefetch-size-changing-command detection section configured to detect a command to change a prefetch size of data transferred from a memory to a prefetch buffer; a transfer-state monitoring section configured to monitor a state of transferring data between the memory and the prefetch buffer; and a prefetch-size changing section configured to immediately change the prefetch size in the prefetch buffer when the command to change the prefetch size is detected and no state of transferring data between the memory and the prefetch buffer is being monitored and to change the prefetch size in the prefetch buffer after completion of the state of transferring data between the memory and the prefetch buffer when the command to change the prefetch size is detected and the state of transferring data between the memory and the prefetch buffer is being monitored.

### BACKGROUND

The present disclosure relates to a memory-access control circuit. More particularly, the present disclosure relates to a memory-access control circuit prefetching data from a memory, a prefetch circuit including the memory-access control circuit, a memory apparatus including the prefetch circuit and an information processing system including the memory apparatus.

Since a processor makes use of a memory as an instruction holding area and a data holding area, during execution of a program, the processor needs to make accesses to the memory frequently and this frequent accesses to the memory are a heavy load to be borne by the memory. In order to reduce the magnitude of this load, that is, in order to reduce the frequency at which the processor makes accesses to the memory, a prefetch buffer may be provided between the processor and the memory in some configurations. Thus, instead of making an access to the memory, the processor can access the prefetch buffer. In the prefetch buffer, data stored in the prefetch buffer is managed in line units which are each composed of a plurality of consecutive words. An access to a word stored in the prefetch buffer is referred to as a cache hit whereas an access to a word not stored in the prefetch buffer is referred to as a cache mishit. If a word desired by the processor is not found in the prefetch buffer in a cache mishit, a plurality of words including the desired word is prefetched in a batch operation from the memory to the preftech buffer.

A transfer size also referred to as a prefetch size is the number of words prefetched in a batch operation from the memory to the preftech buffer in the event of a cache miss. The prefetch size greatly affects the processing execution performance of the processor as follows. If the prefetch size is increased, the performance of the processor is enhanced provided that the words prefetched to the preftech buffer are used in the execution of the processing. If the words prefetched to the preftech buffer are not used in the execution of the processing, on the other hand, the memory access band is undesirably wasted. In order to make the prefetch size variable, for example, there has been proposed a memory controller for holding a variety of prefetch sizes in a provided area-attribute management table which is looked up for a prefetch size in an operation to prefetch words from the memory to the prefetch buffer. For more information on the proposed memory controller, the reader is advised to refer to documents such as Japanese Patent Laid-open No. 2004-240616.

### SUMMARY

In accordance with the existing technology described above, a prefetch size can be assigned to every logical address block. Since the use of the prefetch buffer also depends on the structure of the program, however, it is generally difficult to determine an optimum prefetch size. In addition, if programs having types different from each other are executed, the optimum prefetch size varies from program to program. Thus, a fixed prefetch size may not be proper in some cases.

It is thus an aim of the present disclosure addressing the problems described above to dynamically change the prefetch size of the prefetch buffer.

In order to solve the problems described above, in accordance with a first embodiment of the present disclosure, there is provided a memory-access control circuit including:

a prefetch-size-changing-command detection section configured to detect a command to change a prefetch size of data transferred from a memory to a prefetch buffer;

a transfer-state monitoring section configured to monitor a state of transferring data between the memory and the prefetch buffer; and

a prefetch-size changing section configured to immediately change the prefetch size in the prefetch buffer when the command to change the prefetch size is detected and no state of transferring data between the memory and the prefetch buffer is being monitored and to change the prefetch size in the prefetch buffer after completion of the state of transferring data between the memory and the prefetch buffer when the command to change the prefetch size is detected and the state of transferring data between the memory and the prefetch buffer is being monitored.

In addition, in order to solve the problems described above, in accordance with the first embodiment of the present disclosure, there are provided a prefetch circuit including the memory-access control circuit, a memory apparatus including the prefetch circuit and an information processing system including the memory apparatus. Thus, the present disclosure brings about a capability of dynamically changing the prefetch size of the prefetch buffer.

In addition, in accordance with the first embodiment of the present disclosure, it is possible to provide a configuration in which:

the memory-access control circuit further has an optimum-prefetch-size determination block configured to determine an optimum prefetch size in the prefetch buffer on the basis of statistical information accompanying an access made by a processor as a read access to the memory; and

the prefetch-size changing section changes the prefetch size of the prefetch buffer to the optimum prefetch size.

Thus, the present disclosure brings about a capability of dynamically changing the prefetch size of the prefetch buffer to the optimum prefetch size.

In addition, in accordance with the first embodiment of the present disclosure, it is possible to provide another configuration in which the memory-access control circuit further has:

a read-request-band measurement section configured to measure a read-request band of requests each made by the processor as a read request to the memory;

an average-latency computation section configured to compute average latencies required between the processor and the memory on the basis of the statistical information for a case in which the prefetch size of the prefetch buffer is set at a first prefetch-size value and for a case in which the prefetch size of the prefetch buffer is set at a second prefetch-size value;

a stall-generation-frequency computation section configured to compute stall generation frequencies on the basis of the read-request band and the average latencies for a case in which the prefetch size of the prefetch buffer is set at the first prefetch-size value and for a case in which the prefetch size of the prefetch buffer is set at the second prefetch-size value;

an execution-performance evaluation section configured to evaluate the execution performance of the processor for a case in which the prefetch size of the prefetch buffer is set at the first prefetch-size value and for a case in which the prefetch size of the prefetch buffer is set at the second prefetch-size value; and

an optimum-prefetch-size determination block configured to determine whether the first prefetch-size value or the second prefetch-size value is to be taken as an optimum prefetch size on the basis of a result of the evaluation of the execution performance.

Thus, the present disclosure brings about a capability of determining an optimum prefetch size on the basis of statistical information.

In addition, in accordance with the first embodiment of the present disclosure, it is possible to provide a further configuration in which:

the memory-access control circuit further has a prefetch-size changing register for storing the command for changing the prefetch size of the prefetch buffer; and

the prefetch-size-changing-command detection section detects a command stored in the prefetch-size changing register as the command for changing the prefetch size of the prefetch buffer.

Thus, the present disclosure brings about a capability of detecting the command for changing the prefetch size of the prefetch buffer by reading out a command from the prefetch-size changing register.

In accordance with the present disclosure, the memory-access control circuit is capable of demonstrating an excellent ability to dynamically change the prefetch size of the prefetch buffer.

### BRIEF DESCRIPTION OF THE DRAWINGS

FIG. 1 is a block diagram showing a typical configuration of an information processing system according to an embodiment of the present disclosure;

FIG. 2 is a diagram showing a typical configuration of a bus master interface employed in a processor included in the information processing system according to the embodiment of the present disclosure;

FIG. 3 is a block diagram showing a typical configuration of a prefetch circuit employed in the information processing system as a prefetch circuit according to a first embodiment of the present disclosure;

FIGS. 4A and 4B are diagrams showing typical configurations of a mode changing register according to the first embodiment of the present disclosure;

FIG. 5 is a timing diagram showing timings of operations carried out by the prefetch circuit according to the first embodiment of the present disclosure;

FIG. 6 is a block diagram showing a typical configuration of a prefetch circuit employed in the information processing system as a prefetch circuit according to a second embodiment of the present disclosure; FIG. 7 is a diagram showing contents of an HBURST [2:0] signal in a bus master interface;

FIG. 8 is a block diagram showing a typical configuration of an optimum-prefetch-size determination block employed in the prefetch circuit according to the second embodiment of the present disclosure; and

FIG. 9 shows a flowchart representing a typical procedure of processing carried out by the prefetch circuit according to the second embodiment of the present disclosure.

### DETAIELED DESCRIPTION OF THE PREFERRED EMBODIMENT

Implementations of the present disclosure are described below. In the following description, each of the implementations is referred to as an embodiment. The embodiments are described in chapters arranged as follows:

1: First Embodiment (Dynamic control of the prefetch size)
2: Second Embodiment (Determination of an optimum prefetch size)

### 1: First Embodiment

### Configuration of the Information Processing System

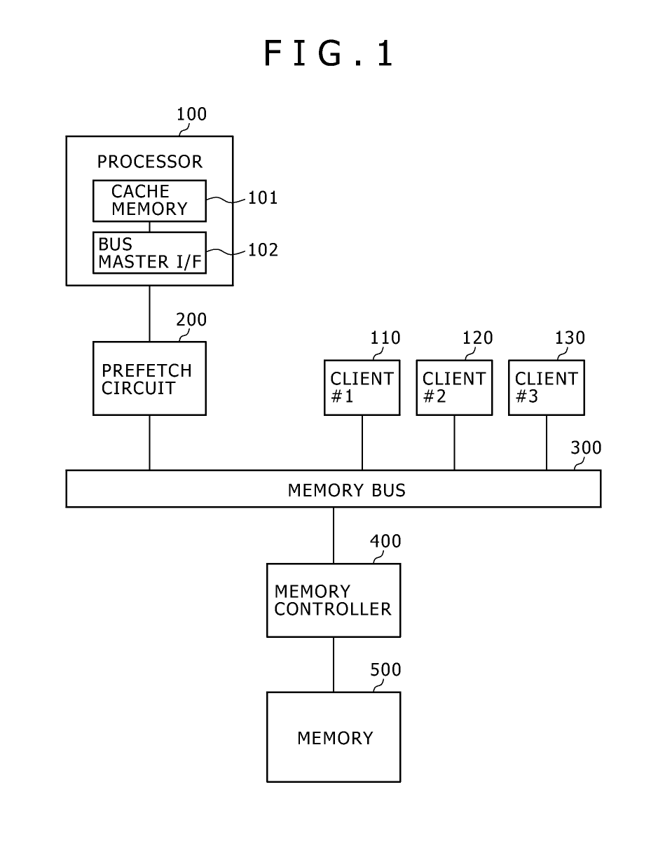

FIG. 1 is a block diagram showing a typical configuration of an information processing system according to an embodiment of the present disclosure. As shown in the figure, the information processing system has a processor 100, clients 110 to 130, a prefetch circuit 200, a memory bus 300, a memory controller 400 and a memory 500.

The processor 100 carries out processing by executing instructions of a program. The instructions of the program have been stored in advance in an instruction holding area in the memory 500. In addition, data required for the processing is stored in a data holding area in the memory 500. A copy of some instructions held in the instruction holding area in the memory 500 is stored in the prefetch circuit 200. By the same token, a copy of a portion of the data held in the data holding area in the memory 500 is stored in the prefetch circuit 200. In addition, the processor 100 includes an internal cache memory 101. A copy of some instructions held in the instruction holding area in the memory 500 is stored in the cache memory 101. By the same token, a copy of a portion of the data held in the data holding area in the memory 500 is stored in the cache memory 101. On top of that, the processor 100 also includes an internal bus master interface 102 for exchanging data with the clients 110, 120 and 130 as well as the memory 500 through the memory bus 300.

The prefetch circuit 200 prefetches a copy of some instructions held in the instruction holding area in the memory 500 and a copy of a portion of the data held in the data holding area in the memory 500, storing the copies in a prefetch buffer 210 which is employed in the prefetch circuit 200 as described later. As will be explained later, the prefetch circuit 200 receives the size of a wrap-around memory access request and a start address. The prefetch circuit 200 converts the size and the start address, supplying results of the conversion to the memory bus 300.

The memory bus 300 is connected to the clients 110, 120 and 130, the prefetch circuit 200 connected to the processor 100 as well as the memory controller 400. Each of the clients 110, 120 and 130 can be regarded as a processor other than the processor 100. The information processing system shown in the figure can be assumed to be a unified memory system even though implementations of the present disclosure are by no means limited to the unified memory system.

The memory controller 400 is a controller for controlling accesses to the memory 500. The memory 500 is a memory shared by the processor 100 and the clients 110, 120 and 130 which can each be regarded as a processor other than the processor 100.

### Bus Master Interface

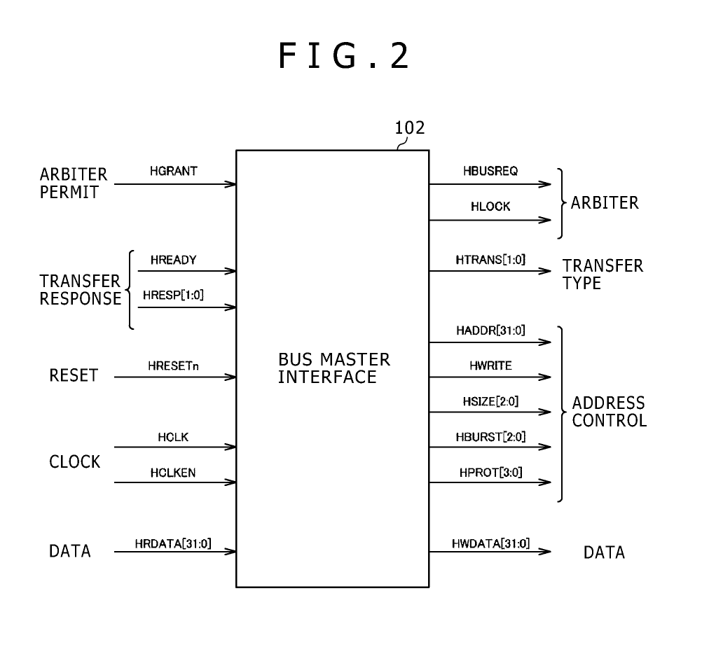

FIG. 2 is a diagram showing a typical configuration of the bus master interface 102 employed in a processor 100 included in the information processing system according to the embodiment of the present disclosure. The bus master interface 102 conforms to an AHB bus master interface made by ARM Company. However, the bus master interface 102 provided by the present disclosure is by no means limited to the AHB bus master interface. For example, the bus master interface 102 can also be applied to other buses making wrap-around memory accesses as is the case with an AXI bus and an OCP bus.

A HGRANT signal is a signal indicating that the transfer is a bus transfer permitted by an arbiter. An HREADY signal is a signal indicating that the current transfer has been ended. An HRESP [1:0] signal is a signal indicating the transfer status. An HRESETn signal is a signal for carrying out a global reset. It is to be noted that the suffix ‘n’ appended to the signal name HRESET indicates that the signal is a low active signal.

An HCLK signal is a bus clock input signal. An HCLKEN signal is a signal enabling the bus clock input signal. An HRDATA [31:0] signal is an input signal conveying data read out from the memory 500.

An HBUSREQ signal is a signal output to the arbiter as a request for a bus transfer. An HLOCK signal is a signal indicating that the access is a locked access. An HTRANS [1:0] signal is a signal indicating the type of the current transfer.

An HADDR [31:0] signal is an address signal conveying a read address or a write address to the memory 500. In the case of a burst transfer, this address signal conveys the first address of the transfer. An HWRITE signal is a signal indicating that the direction of the current transfer is the write direction or the read direction. An HSIZE [2:0] signal is a signal indicating the size of the current transfer. An HBURST [2:0] signal is a signal indicating the burst length of the current transfer. An HPROT [3:0] signal is a protection control signal. An HWDATA [31:0] signal is a signal conveying data, which is to be written into the memory 500, to the memory 500.

The interface described above is an interface between the processor 100 and the prefetch circuit 200 as well as an interface between the prefetch circuit 200 and the memory 500 though the memory bus 300. In order to distinguish the interface between the processor 100 and the prefetch circuit 200 from the interface between the prefetch circuit 200 and the memory 500, however, a prefix ‘A_’ may be appended to each of the signals of the interface between the processor 100 and the prefetch circuit 200 whereas a prefix ‘B_’ may be appended to each of the signals of the interface between the prefetch circuit 200 and the memory 500 in some cases.

### Configuration of the Prefetch Circuit

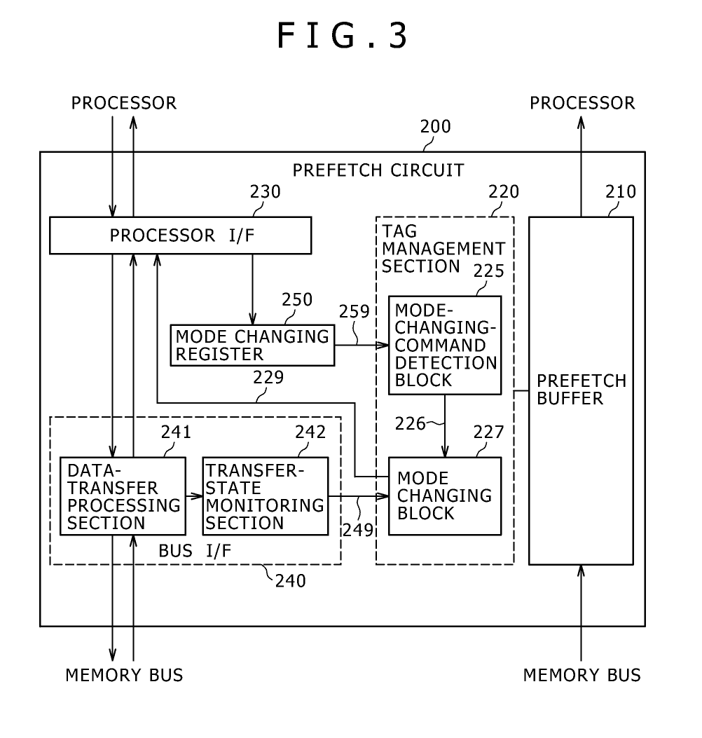

FIG. 3 is a block diagram showing a typical configuration of the prefetch circuit 200 employed in the information processing system as a prefetch circuit 200 according to the first embodiment of the present disclosure. As shown in the figure, the prefetch circuit 200 employs a prefetch buffer 210, a tag management section 220, a processor interface 230, a bus interface 240 and a mode changing register 250.

The prefetch buffer 210 is used for holding a copy of some instructions held in an instruction holding area of the memory 500 for the processor 100. The prefetch buffer 210 is also used for holding a copy of a portion of the data held in a data holding area of the memory 500 for the processor 100. The size of a management unit used in the prefetch buffer 210 is assumed to be greater than a line size of a cache memory 101 employed in the processor 100. The instructions and the data which are held in the prefetch buffer 210 can be logically distinguished from each other. As an alternative, it is possible to provide the prefetch buffer 210 with a configuration in which a buffer for holding the instructions is provided as a buffer separated physically from a buffer for holding the data.

The tag management section 220 is a section for managing tags of addresses of objects held in the prefetch buffer 210 as instructions and data. The tag of an address is some bits selected from a plurality of significant bits in the field of the address. The tag management section 220 employs a mode-changing-command detection block 225 and a mode-changing block 227.

The mode-changing-command detection block 225 is a section for detecting a command to change the mode of the prefetch size in the prefetch buffer 210. The mode-changing block 227 is a section for changing the mode of the prefetch size in the prefetch buffer 210. The mode of the prefetch size is assumed to be typically either of a 32-byte mode or a 64-byte mode which can be switched from each other. For a 32-bit data-bus width, an object can be prefetched in the 32-byte mode from the memory 500 to the prefetch buffer 210 by carrying out a wrap-around burst transfer of 8 bursts. By the same token, for the 32-bit data-bus width, an object can be prefetched in the 64-byte mode from the memory 500 to the prefetch buffer 210 by carrying out a wrap-around burst transfer of 16 bursts. It is to be noted that the mode-changing-command detection block 225 is a typical example of a prefetch-size-changing-command detection section described in a claim of this specification of the present disclosure.

The processor interface 230 is an interface circuit for exchanging signals with the processor 100 whereas the bus interface 240 is an interface circuit for exchanging signals with the memory bus 300. The bus interface 240 employs a data-transfer processing section 241 and a transfer-state monitoring section 242. The data-transfer processing section 241 is a section for carrying out processing to transfer data between the processor 100 and the memory 500 whereas the transfer-state monitoring section 242 is a section for monitoring the data-transfer processing section 241 in order to determine whether or not the data-transfer processing section 241 is carrying out the processing to transfer data between the processor 100 and the memory 500.

The mode changing register 250 is a register for storing a command received from the processor 100 to serve as a command to change the mode of the prefetch size in the prefetch buffer 210. As described later, the mode changing register 250 is assumed to have two types, that is, a register used for storing an instruction and a register used for storing data. As an alternative, however, the register used for storing an instruction and the register used for storing data can be implemented as one register. It is to be noted that the mode changing register 250 is a typical example of a prefetch-size changing register described in a claim of this specification of the present disclosure.

In an operation to change the prefetch size in the prefetch buffer 210, the processor 100 sets a mode flag in the mode changing register 250. As the mode flag in the mode changing register 250 is set, the setting of the mode flag is reported to the tag management section 220 through a signal line 259. In the tag management section 220, the mode-changing-command detection block 225 detects the command stored in the mode changing register 250 to serve as a command to change the mode of the prefetch size and reports the result of the detection to the mode-changing block 227 through a signal line 226.

In the mean time, the transfer-state monitoring section 242 monitors the state of the data-transfer processing section 241 in order to determine whether or not the data-transfer processing section 241 is carrying out processing to transfer data between the processor 100 and the memory 500. The transfer-state monitoring section 242 reports the result of this determination to the mode-changing block 227 through a signal line 249 as a result of the monitoring.

When the mode-changing block 227 is informed by the mode-changing-command detection block 225 of a command detected by the mode-changing-command detection block 225 to serve as a command to change the mode of the prefetch size in the prefetch buffer 210, the mode-changing block 227 immediately changes the mode of the prefetch size provided that the data-transfer processing section 241 is not carrying out processing to transfer data between the processor 100 and the memory 500. If the data-transfer processing section 241 is carrying out processing to transfer data between the processor 100 and the memory 500, on the other hand, the mode-changing block 227 changes the mode of the prefetch size in the prefetch buffer 210 after waiting for the data-transfer processing section 241 to terminate the data-transfer processing when the mode-changing block 227 is informed by the mode-changing-command detection block 225 of a command detected by the mode-changing-command detection block 225 to serve as a command to change the mode of the prefetch size. In addition, the mode-changing block 227 informs through a signal line 229 the processor interface 230 of the state of the processing to change the mode of the prefetch size in the prefetch buffer 210. While the mode-changing block 227 is carrying out the processing to change the mode of the prefetch size in the prefetch buffer 210, the processor interface 230 sustains the A_HREADY signal in the inverted state in order to prevent the processor 100 from issuing the next command to the prefetch circuit 200. It is to be noted that the mode-changing block 227 is a typical example of a prefetch-size changing section described in a claim of this specification of the present disclosure.

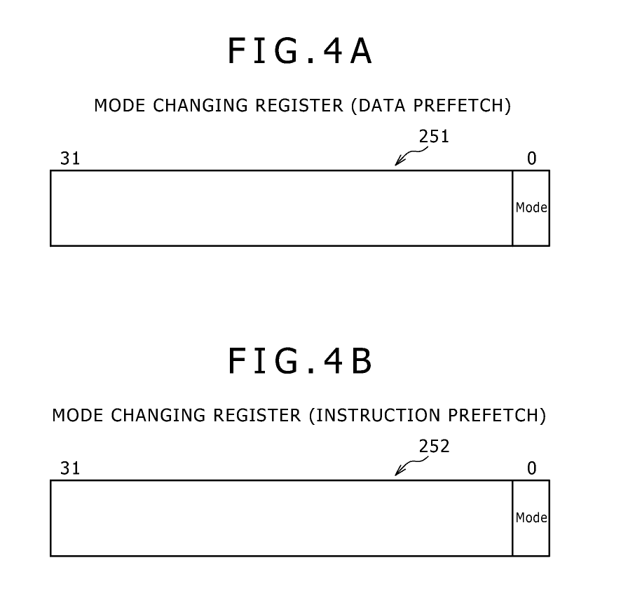

FIGS. 4A and 4B are diagrams showing typical configurations of the mode changing register 250 according to the first embodiment of the present disclosure. To be more specific, FIG. 4A is a diagram showing a typical configuration of a register 251 used for storing a command to change a prefetch size of data in the prefetch buffer 210 whereas FIG. 4B is a diagram showing a typical configuration of a register 252 used for storing a command to change a prefetch size for instructions in the prefetch buffer 210. Even though the register 251 is provided for data while the register 252 is provided for instructions, the field configuration of the register 251 is identical with the field configuration of the register 252. These registers 251 and 252 can be implemented physically as a single register referred to in logically different ways or implemented as two physically different registers.

The registers 251 and 252 are each assumed to have a 32-bit configuration. The least significant bits of the registers 251 and 252 are each a mode flag showing the mode of the prefetch size. For example, a mode flag of 0 is a 32-byte mode indicating that the prefetch size be set at 32 bytes. On the other hand, a mode flag of 1 is a 64-byte mode indicating that the prefetch size be set at 64 bytes. In order to set the prefetch size, a tag in the tag management section 220 is made invalid. After the operation to make the tag invalid has been completed, the prefetch size is set. If the data-transfer processing section 241 is carrying out processing to transfer data between the processor 100 and the memory 500, however, the operation to make the tag invalid is delayed.

### Operations of the Prefetch Circuit

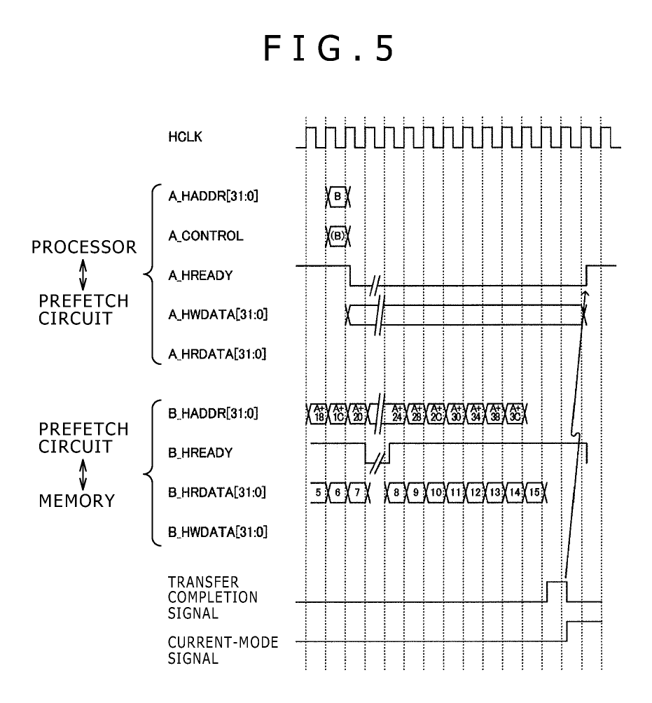

FIG. 5 is a timing diagram showing timings of operations carried out by the prefetch circuit 200 according to the first embodiment of the present disclosure. It is assumed that, while data read out from the memory 500 is being transferred to the prefetch buffer 210 in the operations, the processor 100 sets a prefetch-size changing command in the mode changing register 250 to change the prefetch size from 32 bytes to 64 bytes.

After the prefetch-size changing command has been set in the mode changing register 250, the processor interface 230 sustains the A_HREADY signal in the inverted state in order to prevent the processor 100 from issuing the next command to the prefetch circuit 200. Then, after an operation to transfer data read out from the memory 500 has been completed, the transfer-state monitoring section 242 transmits a transfer termination signal to the mode-changing block 227 through the signal line 249. After waiting for the transfer termination signal to arrive at the mode-changing block 227, the tag management section 220 invalidates the tag and a current mode signal changes the mode flag from 0 indicating the 32-byte mode to 1 indicating the 64-byte mode. Then, the processor interface 230 activates the A_HREADY signal in order to put the prefetch circuit 200 in a state of being ready to receive the next command from the processor 100.

As described above, in accordance with the first embodiment of the present disclosure, it is possible to dynamically change the prefetch size in the course of an operation carried out by the processor 100 while sustaining coherency of data.

### 2SECOND EMBODIMENT

In a second embodiment of the present disclosure, an optimum prefetch size in the prefetch buffer 210 is determined on the basis of statistical information accompanying an access issued by the processor 100 as a read access to the memory 500. Also in the case of the second embodiment, the information processing system having the typical configuration explained earlier by referring to FIG. 1 is assumed.

### Configuration of the Prefetch Circuit

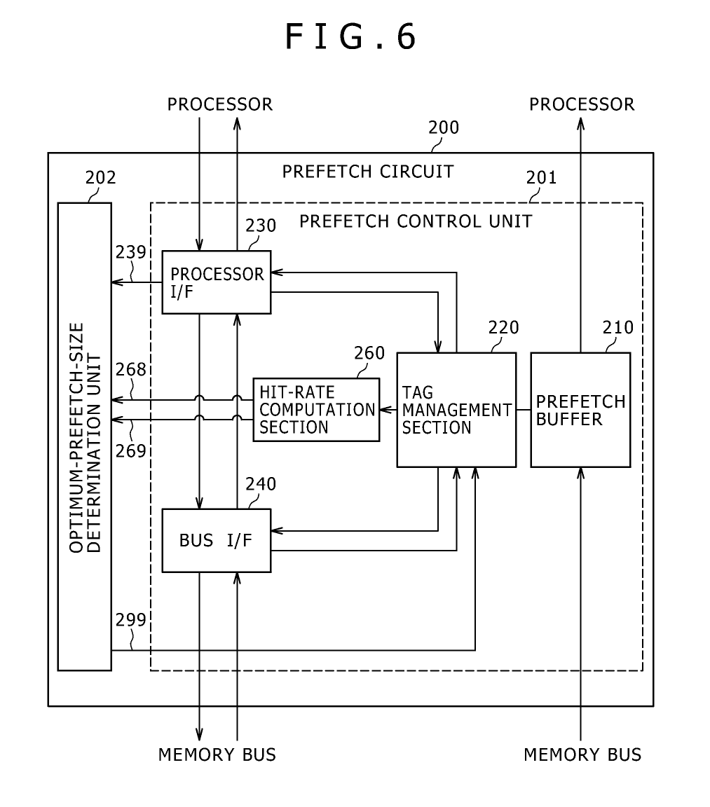

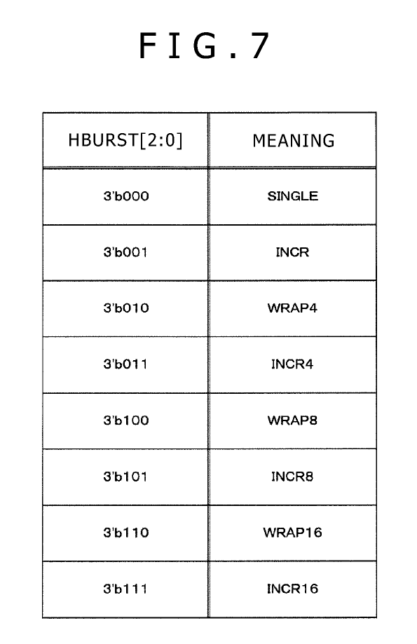

FIG. 6 is a block diagram showing a typical configuration of the prefetch circuit 200 employed in the information processing system as a prefetch circuit 200 according to the second embodiment of the present disclosure. As shown in the figure, the prefetch circuit 200 according to the second embodiment of the present disclosure employs a prefetch control block 201 and an optimum-prefetch-size determination block 202. The basic configuration of the prefetch control block 201 includes the same sections as the prefetch circuit 200 explained earlier by referring to FIG. 3 to serve as the prefetch circuit 200 according to the first embodiment. That is to say, the prefetch control block 201 employs a prefetch buffer 210, a tag management section 220, a processor interface 230, and a bus interface 240.

In addition, the prefetch control block 201 employed in the prefetch circuit 200 according to the second embodiment also has a hit-rate computation section 260. The hit-rate computation section 260 is a section for computing a hit rate for every prefetch size on the basis of statistical information accompanying an access issued by the processor 100 as a read access to the memory 500. The hit-rate computation section 260 supplies the computed hit rate to the optimum-prefetch-size determination block 202 through a signal line 268 or 269. For the sake of convenience, the hit-rate computation section 260 is included in the prefetch control block 201 in this typical configuration. It is to be noted, however, that the hit-rate computation section 260 may be included in the optimum-prefetch-size determination block 202.

FIG. 7 is a diagram showing the contents of the HBURST [2:0] signal in the bus master interface 102. If the contents of the HBURST [2:0] signal are set at 3′b000,the HBURST [2:0] signal indicates a single transfer. It is to be noted that the expression n′b0 . . . 0 represents a string of n bits. In this case of 3′b000, the value of n is 3 indicating that the string is a string of 3 bits.

If the contents of the HBURST [2:0] signal are set at 3′b001, the HBURST [2:0] signal indicates an incremental burst transfer (INCR) with no specified length. The incremental burst transfer is a transfer in which, in a transfer of each burst, a fixed value is added to the address.

If the contents of the HBURST [2:0] signal are set at 3′b010,the HBURST [2:0] signal indicates a 4-burst wrap-around burst transfer (WRAP4). The wrap-around burst transfer is a transfer in which an address is added in a specific address range and, on a wrap boundary, the address is wrapped around. In this case, a wrap-around memory access is interpreted to imply the same thing as the wrap-around burst transfer.

If the contents of the HBURST [2:0] signal are set at 3′b011, the HBURST [2:0] signal indicates an 4-burst incremental burst transfer (INCR4). If the contents of the HBURST [2:0] signal are set at 3′b100, the HBURST [2:0] signal indicates an 8-burst wrap-around burst transfer (WRAP8). If the contents of the HBURST [2:0] signal are set at 3′b101,the HBURST [2:0] signal indicates an 8-burst incremental burst transfer (INCR8). If the contents of the HBURST [2:0] signal are set at 3′b110, the HBURST [2:0] signal indicates a 16-burst wrap-around burst transfer (WRAP16). If the contents of the HBURST [2:0] signal are set at 3′b111, the HBURST [2:0] signal indicates a 16-burst incremental burst transfer (INCR16).

When the processor 100 issues a WRAP4 instruction to the prefetch circuit 200 by making use of the A_HBURST [2:0] signal, depending on the prefetch mode, the bus interface 240 issues a WRAP8 or WRAP16 instruction to the memory 500 by making use of the B_HBURST [2:0] signal. That is to say, if the prefetch mode is the 32-byte mode, the bus interface 240 issues a WRAP8 instruction to the memory 500 by making use of the B_HBURST [2:0] signal. If the prefetch mode is the 64-byte mode, on the other hand, the bus interface 240 issues a WRAP16 instruction to the memory 500 by making use of the B_HBURST [2:0] signal.

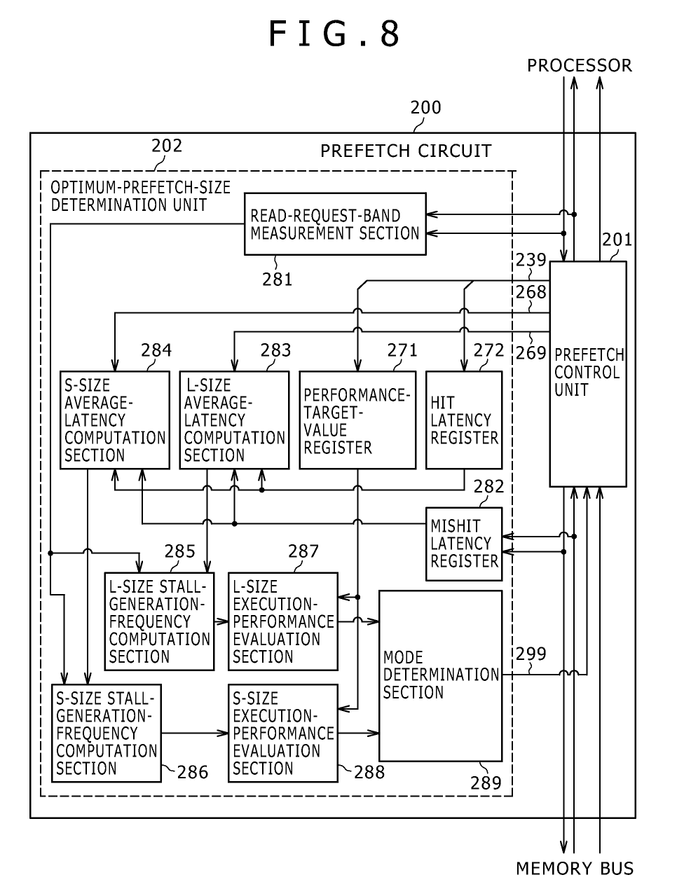

FIG. 8 is a block diagram showing a typical configuration of the optimum-prefetch-size determination block 202 employed in the prefetch circuit 200 according to the second embodiment of the present disclosure. The optimum-prefetch-size determination block 202 is a section for determining which of an L size and an S size is the prefetch size proper for the mode of the prefetch buffer 210. In this case, the relation L size>S size holds true. For example, the L and S sizes can be assumed to be 64 and 32 bytes respectively. The optimum-prefetch-size determination block 202 has a performance-target-value register 271 and a hit-latency register 272. In addition, the optimum-prefetch-size determination block 202 also includes a read-request-band measurement section 281 and a mishit-latency measurement section 282. On top of that, the optimum-prefetch-size determination block 202 also employs an L-size average-latency computation section 283 and an S-size average-latency computation section 284 for two prefetch sizes respectively, that is, for the L and S sizes respectively, an L-size stall-generation-frequency computation section 285 and an S-size stall-generation-frequency computation section 286 for the two prefetch sizes respectively, that is, for the L and S sizes respectively as well as an L-size execution-performance evaluation section 287 and an S-size execution-performance evaluation section 288 for the two prefetch sizes respectively, that is, for the L and S sizes respectively. Furthermore, the optimum-prefetch-size determination block 202 also has a mode determination section 289.

The performance-target-value register 271 is a register for holding the target value of the performance of the processor 100 as a target value used for determining the mode of the prefetch size. For example, a MIPS (Million Instructions Per Second) value can be used as the target value of the performance of the processor 100. The target value of the performance of the processor 100 can be determined in accordance with system specifications and is set by the processor interface 230 in the performance-target-value register 271 through a signal line 239.

The hit-latency register 272 is a register for holding a latency for a case in which the prefetch buffer 210 has been hit. The latency is the number of cycles required between issuance of a read request made by the processor 100 and arrival of reply data desired by the read request at the processor 100. If the prefetch buffer 210 has been hit, the computed latency is a constant which is stored in the hit-latency register 272. The processor interface 230 sets the hit latency in the hit-latecncy latency register 272 through the signal line 239.

The read-request-band measurement section 281 is a section for measuring the band of read requests made by the processor 100 per second at any one given point in time on the basis of the number of bytes of reply data output to the processor 100. The unit of the read-request band can typically be MB/s (megabytes per second). The result of the measurement carried out by the read-request-band measurement section 281 is updated every time a read request made by the processor 100 is received. The result of the measurement carried out during the last 1 second is supplied to the L-size stall-generation-frequency computation section 285 and the S-size stall-generation-frequency computation section 286.

The mishit-latency measurement section 282 is a section for measuring a latency for a case in which the prefetch buffer 210 has been mishit. If the prefetch buffer 210 has been mishit, a burst access to the memory 500 is made. Thus, the time between issuance of a read request made by the processor 100 and arrival of reply data desired by the read request at the processor 100 is the time it takes to make an access to the memory 500. The result of the measurement carried out by the mishit-latency measurement section 282 is supplied to the L-size average-latency computation section 283 and the S-size average-latency computation section 284.

The L-size average-latency computation section 283 and the S-size average-latency computation section 284 are sections for computing average latencies for the modes of the prefetch sizes. To be more specific, the L-size average-latency computation section 283 is a section for computing an average latency for the L size whereas the S-size average-latency computation section 284 is a section for computing an average latency for the S size. Since the hit rate for the L size is different from the hit rate for the S size, the L-size average-latency computation section 283 and the S-size average-latency computation section 284 compute average latencies for the modes of the prefetch sizes. The hit-rate computation section 260 supplies the hit rate for the S size to the S-size average-latency computation section 284 through a signal line 268 and the hit rate for the L size to the L-size average-latency computation section 283 through a signal line 269.

Let notation A denote the hit latency held in the hit-latency register 272 whereas notation B denote the mishit latency measured by the mishit-latency measurement section 282. In addition, let notation X denote a hit rate computed by the hit-rate computation section 260 as the hit rate for the S size. In this case, the average latency LS for the S size can be obtained in accordance with the following equation:

LS=A×X+B×(1−X)

Let notation Y denote a hit rate computed by the hit-rate computation section 260 as the hit rate for the L size. In this case, the average latency LL for the L size can be obtained in accordance with the following equation:

LL=A×Y+B×(1−Y)

The L-size average-latency computation section 283 computes the average latency LL for the L size whereas the S-size average-latency computation section 284 computes the average latency LS for the S size.

The L-size stall-generation-frequency computation section 285 and the S-size stall-generation-frequency computation section 286 are sections for computing stall generation frequencies for the modes of the prefetch sizes. To be more specific, the L-size stall-generation-frequency computation section 285 is a section for computing a stall generation frequency for the L size whereas the S-size stall-generation-frequency computation section 286 is a section for computing a stall generation frequency for the S size. The stall generation frequency is the number of stalls of the processor 100 per second. Let notation Q denote the read-request band measured by the read-request-band measurement section 281 and let the S size be set at 32 bytes. In this case, the stall generation frequency SS for the S size can be found in accordance with the following equation:

SS=LS×Q/32

Let the L size be set at 64 bytes. In this case, the stall generation frequency SL for the L size can be found in accordance with the following equation:

SL=LL×Q/64

The L-size stall-generation-frequency computation section 285 computes the stall generation frequency SL for the L size whereas the S-size stall-generation-frequency computation section 286 computes the stall generation frequency SS for the S size.

The L-size execution-performance evaluation section 287 and the S-size execution-performance evaluation section 288 are sections for determining whether or not the stall generation frequency is within a range tolerated by performance target values for the modes of the prefetch sizes. To be more specific, the L-size execution-performance evaluation section 287 is a section for determining whether or not the stall generation frequency is within a range tolerated by a performance target value for the L size whereas the S-size execution-performance evaluation section 288 is a section for determining whether or not the stall generation frequency is within a range tolerated by a performance target value for the S size. The performance value of the processor 100 is expressed by the following equation:

Processor performance value [MIPS]=Processor operating frequency [MHz]−Stall generation frequency [MHz]/CPI

Notation CPI (Cycles Per Instruction) used in the above equation denotes the number of execution cycles per instruction. In this case, on the assumption that the CPI is equal to 1, the performance value of the processor 100 can be obtained by subtracting the stall generation frequency from the operating frequency of the processor 100. Thus, by comparing the difference (processor operating frequency—processor performance target value) with the stall generation frequency, it is possible to determine whether or not the stall generation frequency is within a range tolerated by a performance target value.

That is to say, the L-size execution-performance evaluation section 287 compares a value obtained as a result of subtracting the processor performance target value held in the performance-target-value register 271 from the operating frequency of the processor 100 with a stall generation frequency computed by the L-size stall-generation-frequency computation section 285 as the stall generation frequency for the L size. If the former is found greater than the latter, the L-size execution-performance evaluation section 287 determines that the stall generation frequency for the L size is within a range tolerated by a performance target value.

In addition, the S-size execution-performance evaluation section 288 compares a value obtained as a result of subtracting the processor performance target value held in the performance-target-value register 271 from the operating frequency of the processor 100 with a stall generation frequency computed by the S-size stall-generation-frequency computation section 286 as the stall generation frequency for the S size. If the former is found greater than the latter, the S-size execution-performance evaluation section 288 determines that the stall generation frequency for the S size is within a range tolerated by a performance target value.

The mode determination section 289 is a section for determining the mode of the prefetch in accordance with results of the evaluations carried out by the L-size execution-performance evaluation section 287 and the S-size execution-performance evaluation section 288. That is to say, if the L-size execution-performance evaluation section 287 determines that the stall generation frequency for the L size is within a range tolerated by a performance target value and the S-size execution-performance evaluation section 288 also determines that the stall generation frequency for the S size is within a range tolerated by a performance target value, the mode determination section 289 selects a smaller size provided by the mode for the S size as an optimum prefetch size.

If the L-size execution-performance evaluation section 287 determines that the stall generation frequency for the L size is within a range tolerated by a performance target value but the S-size execution-performance evaluation section 288 does not determine that the stall generation frequency for the S size is within a range tolerated by a performance target value, the mode determination section 289 selects a mode for the L size as an optimum prefetch size.

If the L-size execution-performance evaluation section 287 does not determine that the stall generation frequency for the L size is within a range tolerated by a performance target value and the S-size execution-performance evaluation section 288 also does not determine that the stall generation frequency for the S size is within a range tolerated by a performance target value, the modes for the S and L sizes cannot be selected as an optimum prefetch size. In this case, an interrupt is generated.

It is to be noted that there is logically no case in which the L-size execution-performance evaluation section 287 does not determine that the stall generation frequency for the L size is within a range tolerated by a performance target value but the S-size execution-performance evaluation section 288 determines that the stall generation frequency for the S size is within a range tolerated by a performance target value.

The mode determination section 289 supplies the optimum prefetch size to the tag management section 220 employed in the prefetch circuit 200 through a signal line 299. It is to be noted that the mode determination section 289 is a typical example of an optimum-prefetch-size determination block described in a claim of this specification of the present disclosure.

The internal configuration of the tag management section 220 is identical with the tag management section 220 employed in the prefetch circuit 200 according to the first embodiment as described before by referring to FIG. 3. That is to say, when the mode-changing-command detection block 225 receives a determination result, which has been produced by the mode determination section 289, from the mode determination section 289 through the signal line 299, the mode-changing-command detection block 225 detects the determination result as a mode changing command. The mode-changing block 227 changes the mode of the prefetch size after waiting for completion of transfer processing carried out in the bus interface 240.

### Operations of the Prefetch Circuit

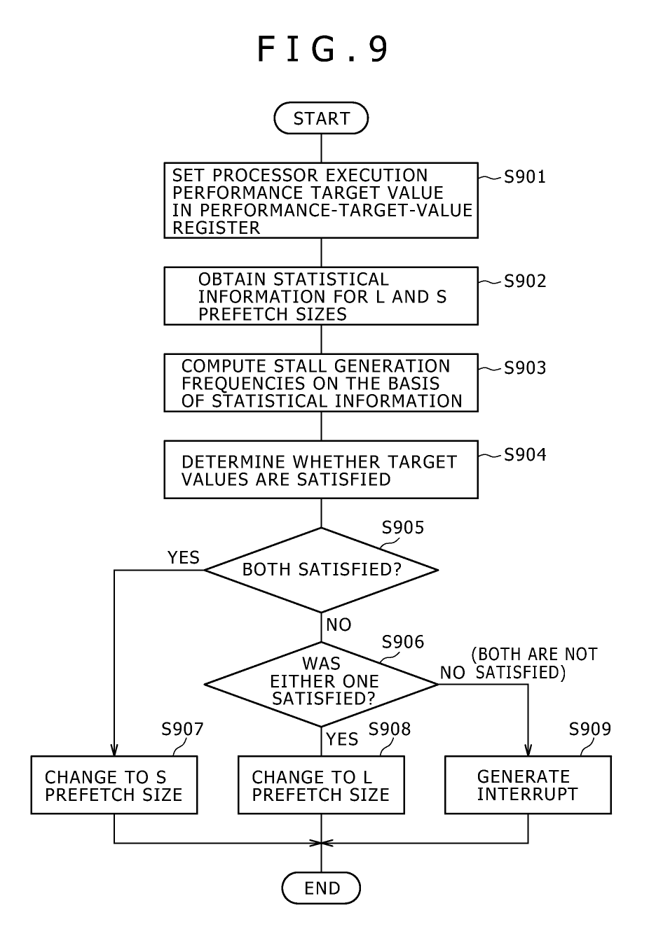

FIG. 9 shows a flowchart representing a typical procedure of processing carried out by the prefetch circuit 200 according to the second embodiment of the present disclosure. As shown in the figure, the flowchart begins with a step S901 at which the target value of the execution performance of the processor 100 is set in advance in the performance-target-value register 271.

Then, at the next step S902, with the prefetch size set at the values for the S-size mode and the L-size mode, the processor 100 executes a program in order to acquire statistical information. In this case, the statistical information is assumed to include a hit rate computed by the hit-rate computation section 260, a read-request band measured by the read-request-band measurement section 281 and a mishit latency measured by the mishit-latency measurement section 282. Then, at the next step S903, on the basis of these pieces of statistical information, the L-size average-latency computation section 283 and the S-size average-latency computation section 284 compute average latencies for the modes of the prefetch sizes whereas, on the basis of the average latencies, the L-size stall-generation-frequency computation section 285 and the S-size stall-generation-frequency computation section 286 compute stall generation frequencies for the modes of the prefetch sizes.

Subsequently, at the next step S904, the L-size execution-performance evaluation section 287 and the S-size execution-performance evaluation section 288 evaluate the stall generation frequencies by determining whether or not the stall generation frequencies satisfy conditions that the stall generation frequencies are within their respective ranges each tolerated by a performance target value. In accordance with evaluation results produced by the L-size execution-performance evaluation section 287 and the S-size execution-performance evaluation section 288 at the step S904, the mode determination section 289 selects the mode of the prefetch size as follows.

At the next step S905, the evaluation results produced by the L-size execution-performance evaluation section 287 and the S-size execution-performance evaluation section 288 at the step S904 are examined in order to determine whether or not both the stall generation frequencies satisfy the conditions described above.

If the determination result produced at the step S905 indicates that both the stall generation frequencies satisfy the conditions, the flow of the procedure goes on to a step S907 at which the mode determination section 289 selects the mode of the S size as an optimum prefetch size. In this way, the mode of the prefetch size is changed.

If the determination result produced at the step S905 indicates that the stall generation frequencies do not both satisfy the conditions, on the other hand, the flow of the procedure goes on to a step S906 at which the evaluation results produced by the L-size execution-performance evaluation section 287 and the S-size execution-performance evaluation section 288 at the step S904 are examined in order to determine whether or not either of the stall generation frequencies satisfies the condition.

If the determination result produced at the step S906 indicates that either of the stall generation frequencies satisfies the condition, the flow of the procedure goes on to a step S908 at which the mode determination section 289 selects the mode of the L size as an optimum prefetch size. In this way, the mode of the prefetch size is changed.

If the determination result produced at the step S906 indicates that both the stall generation frequencies do not satisfy the conditions, on the other hand, the flow of the procedure goes on to a step S909 at which the mode determination section 289 generates an interrupt.

As described above, in accordance with the second embodiment of the present disclosure, an optimum prefetch size is determined on the basis of statistical information so that the prefetch size can be changed dynamically.

It is to be noted that the embodiments of the present disclosure are merely typical implementations of the present disclosure and, as obvious from the description of the embodiments, every element of the embodiments corresponds to an invention-specific element described in claims included in the specification of the present disclosure. By the same token, every invention-specific element described in the claims included in the specification of the present disclosure corresponds to an embodiment element provided with the same name as the invention-specific element to serve as an embodiment element included in an embodiment. However, implementations of the present disclosure are by no means limited to the embodiments of the present disclosure. That is to say, the embodiments of the present disclosure can be changed to a variety of modifications within a range not deviating from essentials of the present disclosure.

The present disclosure contains subject matter related to that disclosed in Japanese Priority Patent Application JP 2011-006574 filed in the Japan Patent Office on Jan. 17, 2011, the entire content of which is hereby incorporated by reference.

What is claimed is:

1. A memory-access control circuit comprising:
a prefetch-size-changing-command detection section configured to detect a command to change a prefetch size of data transferred from a memory to a prefetch buffer;
a transfer-state monitoring section configured to monitor a state of transferring data between said memory and said prefetch buffer; and
a prefetch-size changing section configured to immediately change said prefetch size in said prefetch buffer when said command to change said prefetch size is detected and no state of transferring data between said memory and said prefetch buffer is being monitored and to change said prefetch size in said prefetch buffer after completion of said state of transferring data between said memory and said prefetch buffer when said command to change said prefetch size is detected and said state of transferring data between said memory and said prefetch buffer is being monitored.

2. The memory-access control circuit according to claim 1, said memory-access control circuit further having
an optimum-prefetch-size determination block configured to determine an optimum prefetch size in said prefetch buffer on the basis of statistical information accompanying an access made by a processor as a read access to said memory,
wherein said prefetch-size changing section changes said prefetch size of said prefetch buffer to said optimum prefetch size.

3. The memory-access control circuit according to claim 2, said memory-access control circuit further having:
a read-request-band measurement section configured to measure a read-request band of requests each made by said processor as a read request to said memory;
an average-latency computation section configured to compute average latencies required between said processor and said memory on the basis of said statistical information for a case in which said prefetch size of said prefetch buffer is set at a first prefetch-size value and for a case in which said prefetch size of said prefetch buffer is set at a second prefetch-size value;
a stall-generation-frequency computation section configured to compute stall generation frequencies on the basis of said read-request band and said average latencies for a case in which said prefetch size of said prefetch buffer is set at said first prefetch-size value and for a case in which said prefetch size of said prefetch buffer is set at said second prefetch-size value;
an execution-performance evaluation section configured to evaluate the execution performance of said processor for a case in which said prefetch size of said prefetch buffer is set at said first prefetch-size value and for a case in which said prefetch size of said prefetch buffer is set at said second prefetch-size value; and
an optimum-prefetch-size determination block configured to determine whether said first prefetch-size value or said second prefetch-size value is to be taken as said optimum prefetch size on the basis of a result of said evaluation of said execution performance.

4. The memory-access control circuit according to claim 1, said memory-access control circuit further having
a prefetch-size changing register configured to store said command for changing said prefetch size of said prefetch buffer,
wherein said prefetch-size-changing-command detection section detects a command stored in said prefetch-size changing register to serve as said command for changing said prefetch size of said prefetch buffer.

5. A prefetch circuit comprising:
a prefetch buffer;
a prefetch-size-changing-command detection section configured to detect a command to change a prefetch size of data transferred from a memory to said prefetch buffer;
a transfer-state monitoring section configured to monitor a state of transferring data between said memory and said prefetch buffer; and
a prefetch-size changing section configured to immediately change said prefetch size in said prefetch buffer when said command to change said prefetch size is detected and no state of transferring data between said memory and said prefetch buffer is being monitored and to change said prefetch size in said prefetch buffer after completion of said state of transferring data between said memory and said prefetch buffer when said command to change said prefetch size is detected and said state of transferring data between said memory and said prefetch buffer is being monitored.

6. A memory apparatus comprising:
a memory;
a prefetch buffer used for storing a copy of some data stored in said memory;
a prefetch-size-changing-command detection section configured to detect a command to change a prefetch size of data transferred from said memory to said prefetch buffer;
a transfer-state monitoring section configured to monitor a state of transferring data between said memory and said prefetch buffer; and
a prefetch-size changing section configured to immediately change said prefetch size in said prefetch buffer when said command to change said prefetch size is detected and no state of transferring data between said memory and said prefetch buffer is being monitored and to change said prefetch size in said prefetch buffer after completion of said state of transferring data between said memory and said prefetch buffer when said command to change said prefetch size is detected and said state of transferring data between said memory and said prefetch buffer is being monitored.

7. An information processing system comprising:
a processor;
a memory;
a prefetch buffer used for storing a copy of some data stored in said memory;
a prefetch-size-changing-command detection section configured to detect a command to change a prefetch size of data transferred from said memory to said prefetch buffer;
a transfer-state monitoring section configured to monitor a state of transferring data between said memory and said prefetch buffer; and
a prefetch-size changing section configured to immediately change said prefetch size in said prefetch buffer when said command to change said prefetch size is detected and no state of transferring data between said memory and said prefetch buffer is being monitored and to change said prefetch size in said prefetch buffer after completion of said state of transferring data between said memory and said prefetch buffer when said command to change said prefetch size is detected and said state of transferring data between said memory and said prefetch buffer is being monitored.
